(19) United States
(12) Patent Application Publication
(10) Pub. No.: US 2012/0221376 A1
(43) Pub. Date: Aug. 30, 2012

(54) SYSTEM AND METHOD FOR OPTIMIZATION OF DATA SETS

(75) Inventor: Philip Austin, Nashville, TN (US)

(73) Assignee: INTUITIVE ALLOCATIONS LLC, Nashville, TN (US)

(21) Appl. No.: 13/406,288

(22) Filed: Feb. 27, 2012

Related U.S. Application Data
(60) Provisional application No. 61/446,561, filed on Feb. 25, 2011.

(51) Int. Cl. G06Q 10/04

(52) U.S. Cl. 705/7.28

(57) ABSTRACT

Systems and methods for optimizing a portfolio comprising a plurality of assets, wherein the plurality of assets have a degree of interdependence are disclosed. The method may include estimating expected return rates, levels of risk, and correlation coefficients for a plurality of assets, wherein the assets are of the plurality of assets and the correlation coefficients are associated with the degree of interdependence of the assets; applying a non-standard probability distribution function to the assets to determine a distribution for each asset, wherein the non-standard probability distribution function is based at least on the expected return rate, level of risk, and correlation coefficient of that asset; and calculating an efficient frontier based on the distributions for the assets.

### RELATED APPLICATION

The current application claims priority under 35 U.S.C. §119(e) to U.S. Provisional Patent Application Ser. No. 61/446,561, filed Feb. 25, 2011, and incorporated by reference herein in its entirety.

### TECHNICAL FIELD

The present disclosure relates generally to data optimization, and more particularly to optimizing a data set in order to maximize a desired property of the data set.

### BACKGROUND

As the complexity and importance of large data sets representing real-world issues continue to rise, the importance of accurate data models rises accordingly. While individuals, governments, and corporations invest substantial resources in using data to forecast future outcomes and thus decision-making, these predictions are only as good as the underlying data model(s). Generally, an entity that desires to empirically predict an outcome, whether investment performance, specifics of geological formations, or medical treatment, seeks to optimize a certain characteristic of the data set. For example, in the field of investing, an investor often has a wide variety of assets available in which to invest. Those assets may include, for example, stocks, bonds, currency, and/or land. Before investing, the investor may find it useful to evaluate the risk associated with each of the assets and to identify what collection of assets represents the best investment. Similarly, a geological company exploring a new formation may wish to optimize the exploration area for a given level of (natural resources) return.

In order to optimize the data set for a given characteristic, large data sets are generally analyzed under a set of assumptions uniform to the individual data values. Advances in statistical analysis have furthered the accuracy of such models, while continuing to leave significant issues, including a disconnect between the assumed model of a data value's performance and the observed performance of similar data values; an inability for the standard models to adapt to new types of data values; and unnecessary limitations on the entity responsible for optimization. As the gap between reliance on data models and their efficacy widens, entities relying on large data sets will need new tools to empower the next generation of empirical problem solving.

Example Applications of Portfolio Optimization

The following illustrative examples outline a few fields to which data optimization may be important.

Weather Forecast & Monitoring

Weather patterns may be interpreted and variances used to forecast future patterns. Common techniques exist for modeling weather patterns, seasonal trends and climate data. The data can be used as inputs for forecasting future probabilities. However, typical projections are limited to models based on a standard distribution. It is well know that such tools are inherently unreliable. Indeed, much of the data collected and average amounts are typically recorded. Knowing that it rains an average of 60 days a year is of little value in knowing whether it will rain tomorrow or the day after. More robust technologies have been implemented to provide more informative and, more importantly, access to more data for use in analysis. The extent to which the analysis of that data is useful is dependent on optimization techniques.

Oil & Gas Exploration

Oil and gas companies have to make investment decisions on new acquisition, exploration, and/or development opportunities. Investment can be thought of as a project baseline or a sunk cost to achieve the economic value associated with a firm's operations. In the case of oil drilling, it may be assumed that there will need to be drilling operations, a given of being in the business. However, there are other investments that may be made which may increase the forecast precision such that eventual drilling operations may yield more oil at a lower marginal cost. Additionally, there may be certain fees arranged to transfer certain risks, and incremental capabilities beyond the base case and the cost to attain rights to such benefits may be thought of as options. Portfolio return may be improved by reducing exploration and development risk and optimizing operational efficiencies.

For example, it is common for multiple wells to be drilled within a single field. When drilling a new wellbore within such a field, log data from a nearby “offset” well data is often used to select the drilling equipment and drilling parameter that will be used to drill the new wellbore. This typically involves comparing the performance of drilling devices that were used to drill the offset wells. Certain methods enable more advanced utilization of optimization systems. The performance of a drilling device utilizes logs and drilling parameters from multiple offset wells located in proximity to the location of a desired wellbore. Well logs and drilling data from offset wells can be used to determine important geological properties, technical limitations and different well profiles. The performance of one or more drilling devices and or drilling parameters may then be simulated in context to offset wells and applied over the selected area of interest. The simulated values may then be used to select an optimized drilling device or parameter for drilling a particular wellbore.

Medical Treatment Optimization

The challenge of optimizing medical treatments can be achieved by using existing clinical data as a framework for deriving optimization models. Given a database containing patient profiles and treatment history, general models may be obtained and used to assess the efficacy of various treatments within a selected sample population. These models may then be used in the optimization process to find a treatment that maximizes a patient's probability of success and overall utility. Provided a set of inputs for a patient's condition, medical history, treatment experiences, and objective can be quantified, and optimization models can be applied to evaluate benefit/risk tradeoffs among potential treatment strategies. Screening for an optimal treatment for a patient involves providing the best benefit/risk balance among suggested treatment options.

For example, an optimization methodology may first seek to identify treatments that would add some level of improvement to a patient's condition based on data obtained from a model population. Given a tolerance range, profiles that fall within the desired range may be used to represent the model population. Next, the method may identify associated risks based on clinical data and the patient's unique risk profile. In situations where there are over abundance of profiles that meet the screened criteria, the tolerance threshold can be tightened to get a more refined model. In contrast, if there is a lack of profiles, the tolerance threshold may need to be increased. Model populations derived from a narrow threshold should imply less risk as the added data is more consistent with the indications of the patient seeking treatment. On the other hand, a wide threshold would suggest a high variability of data and, therefore, such treatment options should imply additional risks due to the lack of clinical data used to develop the optimization model. The optimal medication should, for a given level of risk, maximize the expected benefit to the patient. In practice, such an analysis can be used to determine which medication is most likely to meet the patient's objectives. This can be done through a risk-based simulation of expected outcomes around a target objective. Using the model population as a reference, certain factors will be more likely to lower the probability of success than others. The degree to which various factors impact the probability of success is based on a patient's unique risk profile and relevant clinical outcomes demonstrated within the model population. A high frequency of deviations from the target objective would suggest a lower probability of success for a given treatment.

Defining the target outcome or goal for a patient considering a medical treatment is critical to the reliability of optimization models. That is, it is extremely important to identify what the ideal outcome should be. For instance, if a patient is willing to endure a certain degree of unpleasant side effects, such information is important when choosing an optimal treatment. For example, assume one must decide between two treatment options. The first option is expected to be more effective in treating the patient's condition than the second; however, the first option is known to have a relatively higher incidence of unwanted side effects than the other. Discounting the patient's willingness to tolerate a certain degree of side effects could reduce the patient's probability of achieving success on the first medication. That is, if the objective is to maximize treatment benefits and overall well-being of the patient, then the first treatment option may suggest a higher-degree of variability around the target objective compared to the second. On the other hand, accounting for a patient's willingness to endure side effects in the optimization process may increase the probability of success under the first treatment option and perhaps render the second option suboptimal. The intended duration of treatment is also of major importance in the optimization process. Certain treatments may pose additional risks (i.e. tolerance, dependence, etc. . . . ) when used for extended periods of time. Such risks can be identified by evaluating the results collected from sample populations.

Advanced optimization technologies can be used to increase the efficacy of medical treatments. Optimization results can also provide additional insight that may be useful in evaluating a patient's progress when an initial treatment is selected. Primary risks that may prevent a treatment from being successful can be identified early on and, therefore, can be more effectively monitored and addressed during treatment. Given the presence of next-best alternatives determined in the optimization process, it less challenging to switch a patient to a different treatment in the event the initial recommendation is not effective. Optimizing medical treatments using clinical data as a framework for analysis should increase the probability of selecting successful treatments and decrease the likelihood that a patient will need to seek medical attention for the same condition in the future. In addition, from a patient's perspective, the value of receiving proper treatment initially is substantial. By managing the risk associated with various treatments, properly treated patients are less likely to encounter additional health problems resulting from mistreatments and ultimately avoid unnecessary medical costs in the future.

A database of clinical data is necessary to derive appropriate models for implementing optimization techniques. This suggests that more refined models can be realized as such a database gets larger over time and more relevant model populations can be screened using a narrower threshold. Ultimately, applying more relevant models in the optimization process should lower the risk of mistreatment.

Statistical Analysis of a Portfolio

The example portfolios described above all benefit from improved modeling based on optimization routines. Optimization of these portfolios is currently limited to performance forecasts based on a standard probability distribution. However, real-world data rarely, if ever conforms to the standard distribution. As described in more detail below with reference to FIGS. 1-6, improved statistical analyses may improve the optimization routines. Comparing one distribution with that of other assets is one way of measuring the efficacy of an optimization process.

Central tendency may be measured by averages and expected value—these values tell us where the center of a distribution is located. An average return is a number about which past returns fluctuated. An expected return is centrally located with respect to possible future events. Average and expected value are not the only measures of central tendency. The mean of a past series is called its average. The mean value of a probability distribution is called the expected value of the random variable or uncertain event. The mean, is a weighted average of possible events with probabilities or frequencies used as weights. The frequency of events also contains information about securities, and can be used to characterize multiple expected values.

One measure of central tendency is better than another if it generates better efficient portfolios. This is true, in particular, when probability distributions of returns can be described by one of several standard patterns. It may happen, however, that different combinations of measures yield different efficient portfolios. For such cases, alternative measures, a measure of central tendency and a measure of instability, generally produces better efficient portfolios than any other combination of measures. In practice, small difference between distributions can result in different outcomes.

For example, a portfolio may be inefficient if it is possible to obtain higher expected (or average) return with no greater variability of return, or obtain greater certainty of return with no less average of expected return. The problem of separating efficient from inefficient portfolios, when the standard deviation or variance is used as a measure of uncertainty, frequently occurs in practice. For example, an investor may select one of the “efficient” portfolios of an analysis based on expected return and variance. However, the inspection of those portfolios may indicate reasonable variance and range of return, but the probability of loss measure may be unacceptable.

Alternatives to the normal distribution can produce refinements which better represent a portfolio manager's risk tolerance. For example, in the case of investing, ff security returns were not correlated, simple diversification could eliminate risk. Correlations among security returns, however, prevent a similar canceling out of asset returns within the security market. If correlation among securities were perfect, that is all security returns move up and down together in perfect unison, then diversification could do nothing to eliminate risk. The fact that security returns are highly correlated, but not perfectly correlated, implies that diversification can reduce risk but not eliminate it.

However, the correlation among returns may not be the same for all securities. Returns on a security are generally expected to be more correlated with those in the same industry than those of unrelated industries. To reduce risk it may be necessary to avoid a portfolio whose securities are highly correlated with each other.

Correlation may be important in other fields as well. For example, in the field of geological exploration, new fields in geographical proximity may undergo some of the same geological forces. Thus, changes to one location may directly impact another location. Given the size and distribution of, for example, an oil deposit, the impact may vary from one location to another based on a variety of factors including depth, pressure, volume, and other extant wells.

Returning to the investment example, other factors of a portfolio's performance may be important to an optimization routine. For example, a portfolio may consist of assets that are not traditional investment securities, such as real estate leases or rental property. Other “intangible” assets may also be considered, such as intellectual property. The investment prospects of a particular asset can be modeled and characterized separately from the other assets. The presence of portfolios with multiple types of securities is common; however, modeling techniques based on normal distributions are inadequate in that they are not able to capture or particulate certain factors that may be unique for certain assets.

For example, a given investor may be adverse to volatility (variance) and prefer positive skewness. When the skewness is taken into account, the optimal portfolio may lie above the traditional frontier, signifying that if skewness is taken account an investor may get a higher return for the same level of risk. The allocation represented by the optimal mean-variance portfolio may differ from that of the skewness factored portfolio at corresponding levels of risk. Thus, an allocation different from the mean-variance solution may be suggested to the user in order to obtain a higher portfolio return. The importance of skewness lies in the fact that the more non-normal a return series is, the more distorted is the risk implied by the mean-variance model. One can measure this difference in efficiency using the Sharpe ratio, which is the ratio of return per unit of risk.

Additionally, many popular investment securities do not show returns in line with the standard distribution. For example, the expected distribution of returns for a stock option is characterized by unequivocally observable changes in the price of the underlying stock. Each set of simulated values can be used as inputs needed for the purposes of calculating hypothetical market factors. The typical shape of the implied volatility curve for a given maturity depends on the underlying instrument. Equities tend to have skewed curves: compared to at-the-money, implied volatility is substantially higher for low strikes, and slightly lower for high strikes. Currencies tend to have more symmetrical curves, with implied volatility lowest at-the-money, and higher volatilities in both wings. Commodities often have the reverse behavior to equities, with higher implied volatility for higher strikes.

### SUMMARY

In accordance with the teachings of the present disclosure, the disadvantages and problems associated with detecting a denial of service attack on an electronic device may be improved, reduced, or eliminated.

In accordance with one embodiment of the present disclosure, a method for optimizing a portfolio comprising a plurality of assets, wherein the plurality of assets have a degree of interdependence is provided. The method may include estimating a first expected return rate, a first level of risk, and a first correlation coefficient for a first asset, wherein the first asset is one of the plurality of assets and the first correlation coefficient is associated with the degree of interdependence of the first asset; estimating a second expected return rate, a second level of risk, and a second correlation coefficient for a second asset, wherein the second asset is one of the plurality of assets and the second correlation coefficient is associated with the degree of interdependence of the second asset; applying a first non-standard probability distribution function to the first asset to determine a first distribution, wherein the first non-standard probability distribution function is based at least on the first expected return rate, level of risk, and correlation coefficient; applying a second non-standard probability distribution function to the second asset to determine a second distribution, wherein the second non-standard probability distribution function is based at least on the second expected return rate, level of risk, and correlation coefficient; and calculating an efficient frontier based at least on the first and second distributions.

In accordance with another embodiment of the present disclosure, a system for optimizing a portfolio comprising a plurality of assets, wherein the plurality of assets have a degree of interdependence is provided. The system may include an asset analysis engine configured to estimate a first expected return rate, a first level of risk, and a first correlation coefficient for a first asset, wherein the first asset is one of the plurality of assets and the first correlation coefficient is associated with the degree of interdependence of the first asset; estimate a second expected return rate, a second level of risk, and a second correlation coefficient for a second asset, wherein the second asset is one of the plurality of assets and the second correlation coefficient is associated with the degree of interdependence of the second asset; apply a first non-standard probability distribution function to the first asset to determine a first distribution, wherein the first non-standard probability distribution function is based at least on the first expected return rate, level of risk, and correlation coefficient; apply a second non-standard probability distribution function to the second asset to determine a second distribution, wherein the second non-standard probability distribution function is based at least on the second expected return rate, level of risk, and correlation coefficient. The system may also include an optimization engine communicatively coupled to the asset analysis engine, and configured to calculate an efficient frontier based at least on the first and second distributions.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a networked system including a data analyzer communicatively coupled to one or more end user computer(s) and one or more data storage server(s), in accordance with certain embodiments of the present disclosure

FIG. 2 illustrates a flow chart of an example method for optimizing a data set associated with a portfolio of assets, in accordance with certain embodiments of the present disclosure;

FIG. 3 illustrates a flow chart of an example method for setting up a portfolio for analysis, in accordance with certain embodiments of the present disclosure;

FIG. 4 illustrates a flow chart of an example method for analyzing a set of assets associated with a portfolio, in accordance with certain embodiments of the present disclosure;

FIG. 5 illustrates a flow chart of an example method for calculating the weight to be given a portfolio asset, in accordance with certain embodiments of the present disclosure; and

FIG. 6 illustrates a flow chart of an example method for calculating the weight to be given a portfolio asset, in accordance with certain embodiments of the present disclosure.

### DETAILED DESCRIPTION

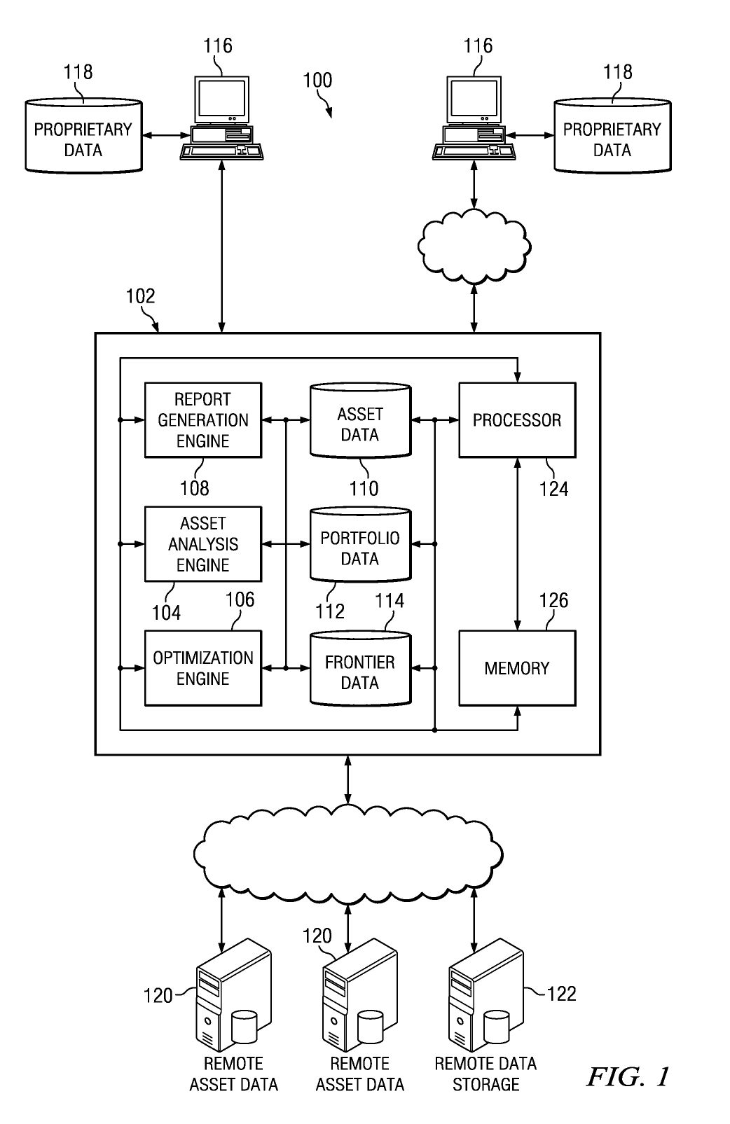

Preferred embodiments and their advantages are best understood by reference to FIGS. 1 through 6, wherein like numbers are used to indicate like and corresponding parts.

For the purposes of the present disclosure, an “asset” may include any resource with measurable characteristics for which future values of those characteristics may be of interest. For example, an asset may include an investment security, geological formation, weather patterns, or medical treatments. A “portfolio” may include any collection of a plurality of assets.

Also for the purposes of this disclosure, an electronic device may include any device, subdevice, or combination of devices and/or subdevices capable of storing, processing, sending, receiving, using, or handling data stored in digital form, including data stored on computer-readable media. Computer-readable media may include any device, subdevice, or combination of devices and/or subdevices configured to store digital data, including without limitation hard disk drives, flash memory, read only memory, random access memory, optical memory, solid state memory, or any other type of removable and/or fixed media used to store digital data. As an illustrative example, an electronic device may be a desktop computer, laptop computer, personal digital assistant, cellular telephone, server, server cluster, etc.

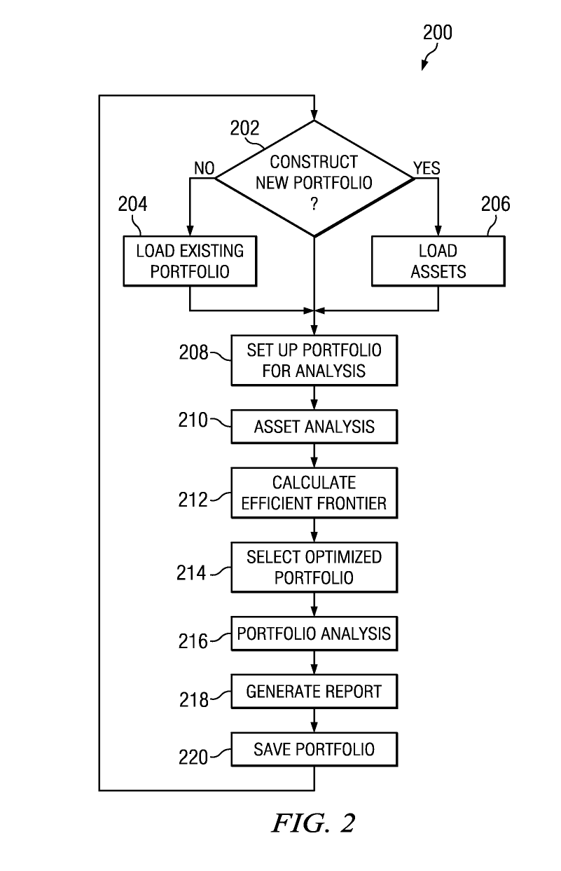

FIG. 1 illustrates a networked system 100 including a data analyzer 102 communicatively coupled to one or more end user computer(s) 116 and one or more data storage server(s) 120, in accordance with certain embodiments of the present disclosure. In some embodiments, data analyzer 102 may be an electronic device configured to analyze a data set representative of a plurality of assets, as described in more detail below with reference to FIGS. 2-6.

In some embodiments, data analyzer 102 may include one or more modules implemented as hardware components and/or stored on computer-readable media and executable by a processor, including asset analysis engine 104, optimization engine 106, and report generation engine 108. Asset analysis engine 104 may be generally operable to analyze a data set associated with a plurality of assets. In some embodiments, this analysis may include a statistical analysis of the data set based on a set of assumptions. In some embodiments, these assumptions may be increased, decreased, or otherwise modified and analyzed repeatedly in order to generate a predictive model of the assets' future performance based on the data set. Asset analysis engine 104 is described in more detail below with reference to FIGS. 2-6.

In addition, to asset analysis engine 104, data analyzer 102 may also include optimization engine 106. In some embodiments, optimization engine 106 may be generally operable to provide one or more optimized version(s) of the portfolio containing the analyzed assets. As described in more detail below with reference to FIG. 2-6, the optimization may include generating one or more optimization frontier(s) based on the analyzed portfolio.

Further, data analyzer 102 may also include report generation engine 108. In some embodiments, report generation engine 108 may be generally operable to present the analyzed data in a more readable format to the end user, as described in more detail below with reference to FIGS. 2-6.

For ease of illustration, asset analysis engine 104, optimization engine 106, report generation engine 108, asset data 110, portfolio data 112, and frontier data 114 are depicted as part of a single electronic device, data analyzer 102. In some embodiments, the various modules and/or data sources of data analyzer 102 may be present in the same or multiple electronic devices.

In some embodiments, the various modules of data analyzer 102 may be configured to retrieve and/or transmit data from various data sources. These data sources may be in the form of flat files, relational database, or any appropriate data structure. Additionally, the data sources may be stored locally on the same machine as data analyzer 102, in a separate data storage electronic device, some combination of local and distributed storage, and/or any other appropriate storage mechanism configured to retrieve and/or transmit data to the various modules of data analyzer 102. As an illustrative example, data analyzer 102 may include asset data 110, portfolio data 112, and/or frontier data 114. As described in more detail below with reference to FIGS. 2-6, asset analysis engine 104, optimization engine 106, and/or report generation engine 108 may require access to large volumes of data stored in one or more data sources. As an illustrative example, asset data 110 may include data associated with a plurality of assets (e.g., values of specific properties associated with the assets); portfolio data 112 may include data associated with the combination of the plurality of assets (e.g., weights associated with individual assets within the portfolio); and frontier data 114 may include data associated with the optimization of the portfolio (e.g., sampled data based on the assumed distribution of the assets' performances).

In some embodiments, data analyzer 102 may be communicatively coupled to one or more end user computer(s) 116. End user computer(s) 116 may be an electronic device configured to transmit and/or receive data from data analyzer 102. As an illustrative example, end user computer(s) 116 may be a desktop computer. In some embodiments, end user computer(s) may be communicatively coupled to data analyzer 102 via a network such as a local area network, wide area network, or the internet. In the same or alternative embodiments, end user computer(s) 116 may be communicatively coupled to data analyzer through a direct connection such as a universal serial bus adapter or other appropriate data connection. In still other embodiments, data analyzer 102 may reside on the same electronic device as end user computer(s) 116.

In some embodiments, end user computer(s) 116 may also be communicatively coupled to proprietary data 118. Proprietary data may be any local data source, remote data source, or some combination thereof, configured to receive and/or transmit proprietary data to end user computer(s) 116. In some embodiments, proprietary data 118 may include data individual to an end user. As an illustrative example, proprietary data 118 may include transaction cost data or other data proprietary to the end user. In configurations of networked system 100 wherein multiple end users are accessing data analyzer 102 (e.g., in a cloud computing and/or software as a service context), it may be advantageous for the end user to maintain certain data apart from data analyzer 102.

In addition to end user computer(s) 116, data analyzer 102 may also be communicatively coupled to one or more remote data sources 120. In some embodiments, remote data sources 120 may be privately and/or publicly available information useful in the data analysis provided by data analyzer 102. As an illustrative example, in the case of the data set representing securities assets for investing, remote data sources 120 may hold publicly available data such as ticker information for individual assets. As another illustrative example, in the case of the data set representing geological features, remote data sources 120 may hold private data gathered from geological exploration.

In some embodiments, networked system 100 may also include remote data storage 122. Remote data storage 122 may be configured to receive data from data analyzer 102 for the purposes of secure and/or backup storage. In some embodiments, remote data storage 122 may be included in networked system 100 as a replacement and/or supplement to data storage available locally to data analyzer 102.

In operation, a user of end user computer(s) 116 may initiate a data analysis session with data analyzer 102. The user may be an end user and/or another end user computer 116. The user may instruct data analyzer 102 which data set to analyze and under what circumstances. As an illustrative example, a user may select a portfolio of securities assets for the purposes of investment planning Once the portfolio of assets is selected, data analyzer 102 may perform a statistical analysis on the portfolio in order to determine a model of its expected performance. In some embodiments, data analyzer 102 may also perform an optimization of the portfolio in order to determine a delta between the current expected performance and an optimal expected performance. The user may then select a modified version of the portfolio according to the optimization. In some embodiments, these versions may represent the same portfolio of assets optimized for different values of performance characteristics. As an illustrative example, in the case of investment analysis, data analyzer 102 may generate optimized portfolios differing based on the amount of risk the user is willing to accept. For example, a user may select one optimized portfolio to maximize return for a given risk value or may select a different optimized portfolio to minimize risk for a given expected return. The multiple optimized portfolios available to the user may be generally plotted according to the performance characteristics of interest to the user. A trend line connecting the optimized portfolios may be referred to as a “frontier.”

At any part of the analysis and/or optimization process, data analyzer 102 may also generate one or more reports for communication with the user. These reports may include any formatting of the raw and/or analyzed data in a format more easily readable by the user. The report may be generated and/or delivered in any appropriate format, including electronically. Also, in some embodiments, the report may be a graphical depiction of the data analysis. As an illustrative example, a graph of the optimized frontier displayed on a computer screen may be a report to the user.

The computer-implemented procedures of the invention may be embodied in machine-executable instructions. The instructions can be used to cause a processor which is programmed with the instructions to perform the steps:

(a) Calculating approximate values for stable variables, α, β, c, and π, for a given set of return data.

(b) Displaying a graphical representation for the stable distribution of an asset described by the approximated variables calculated in (a).

(c) Displaying a graphical representation of a fractional allocation for each asset of a portfolio at each return probability level.

As would be recognized by one of ordinary skill in the art, the systems and methods described herein with reference to FIGS. 1-6 may be applied to any field in which accurate modeling of future performance of a portfolio of assets may be desirable. As an illustrative example, one such field may be investment analysis.

Managers of investment portfolios, such as portfolios of bonds, commodities, currencies, equities and/or other assets, including land, often seek to identify a collection of assets that will maximize the return of a given portfolio for a defined level of risk or minimize the risk needed to achieve a defined level of return. A portfolio containing a collection of assets that meets one of these two goals may be known as an efficient portfolio.

Various methods may be used to create an efficient portfolio. One such method for efficient portfolio selection relies on assigning each asset in a portfolio with a predetermined rate of return and a predetermined level of risk. The assets, along with their associated data, may then be analyzed collectively with the goal of identifying and selecting combinations of assets that achieve one of the two goals mentioned above, as well as other goals or requirements which an asset manager may wish to incorporate into a management strategy.

FIG. 2 illustrates a flow chart of an example method 200 for optimizing a data set associated with a portfolio of assets, in accordance with certain embodiments of the present disclosure. Method 200 includes setting up a portfolio for analysis, analyzing the assets in the portfolio, performing an optimization analysis, and reporting the results to a user.

According to one embodiment, method 200 preferably begins at step 202. Teachings of the present disclosure may be implemented in a variety of configurations of networked system 100. As such, the preferred initialization point for method 200 and the order of steps 202-220 comprising method 200 may depend on the implementation chosen.

At step 202, a user may decide whether to construct a new portfolio. For example, if the user is performing method 200 for the first time, the user may need to construct a portfolio from scratch. If the user needs to construct a new portfolio, method 200 may proceed to step 206. At step 206, a user may load data associated with a plurality of assets. In some embodiments, a user, through end user computer 116, may load asset data from any combination of asset data 110, end user computer 116, proprietary data 118, remote data storage 122, and/or remote data source 120, as described in more detail above with reference to FIG. 1. As an illustrative example, a user desiring to build a portfolio representative of investment securities may load data associated with the selected securities, such as past performance over a given timeframe. After loading the data associated with the plurality of assets, method 200 may proceed to step 208.

If no new portfolio was needed at step 202, method 200 may proceed to step 204. At step 204, method 200 may load an existing portfolio. In some embodiments, data analyzer may load the existing portfolio from some combination of end user computer 116, proprietary data 118, asset data 110, portfolio data 112, remote data storage 122, and/or remote data source 120. As an illustrative example, portfolio data 112 may contain data representative of the portfolio as a whole, e.g., which assets are included, while asset data 110 may include data associated with the individual assets. As an illustrative example, a user desiring to load a portfolio representative of investment securities may load a previously created portfolio. After loading the existing portfolio, method 200 may proceed to step 208.

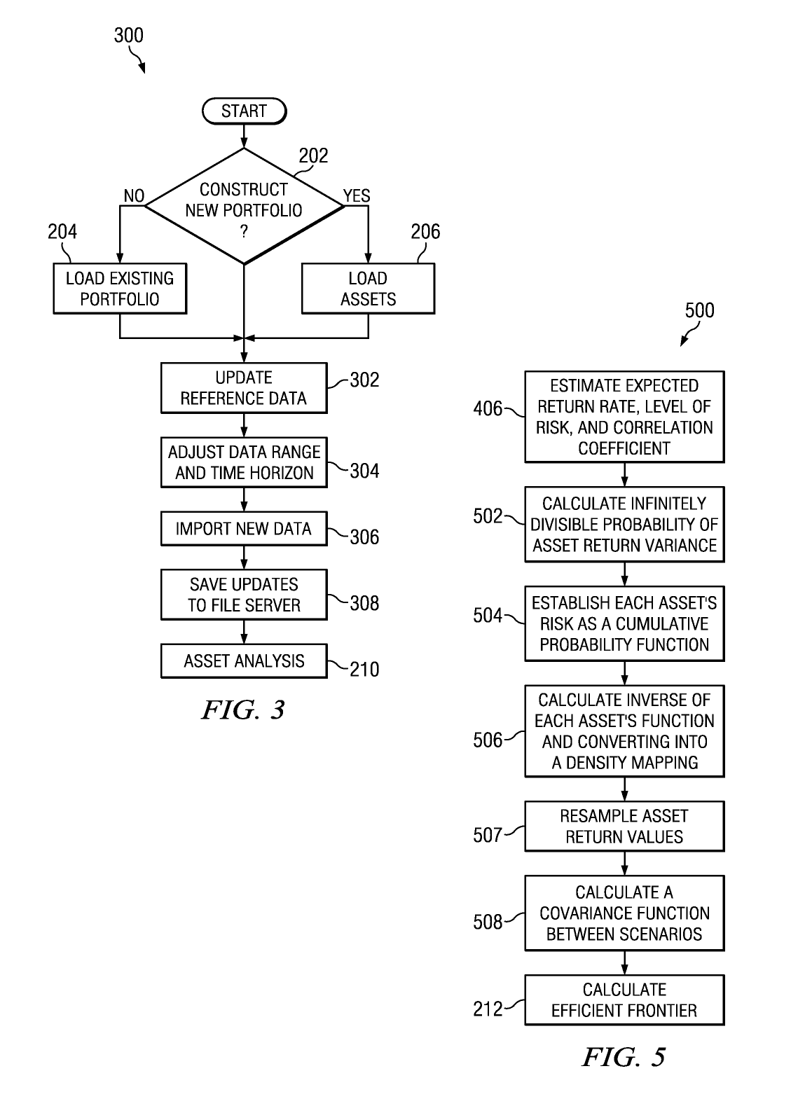

At step 208, method 200 may set up the portfolio for analysis. As described in more detail below with reference to FIG. 3, setting up the portfolio for analysis may include selecting the assets to be analyzed, updating reference data, adjusting the data range and time horizon, importing new data, and saving updates. In some embodiments, step 208 may be performed by asset analysis engine 108 of data analyzer 102. In the same or alternative embodiments, reference data and time horizon data may be stored at, for example, portfolio data 112 and/or remote data source 120. Additionally, new asset data may be stored at, for example, asset data 110 and/or remote data source 120. In some embodiments, a user may also have user-specific data to load as part of the portfolio setup. For example, a user may wish to include certain transaction cost data in the portfolio analysis. In such embodiments, additional data may be supplied by the user from end user computer 116 from, for example, proprietary data 118.

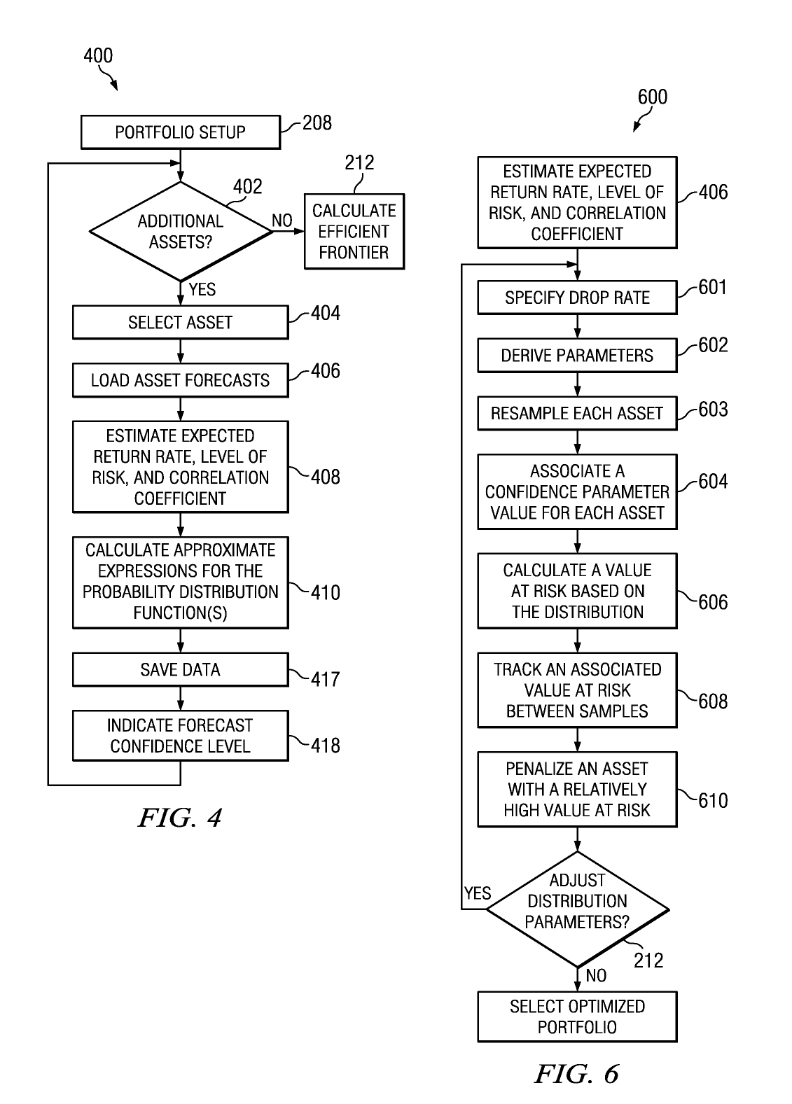

After setting up the portfolio for analysis, method 200 may proceed to step 210. At step 210, method 200 may analyze each asset to determine the appropriate weight to be given the asset within the portfolio, as described in more detail below with reference to FIG. 4. In some embodiments, step 210 may be performed by asset analysis engine 104 of data analyzer 102.

To begin analyzing a portfolio of assets, each asset in the portfolio may be assigned an expected rate of return and a level of risk, as described in more detail below with reference to FIGS. 4-6. In some embodiments, the level of risk may be expressed as a standard deviation (or variance) of return. Each asset may also be assigned a correlation coefficient value that describes each asset's return in relation to every other asset, and/or in relation to all assets, in the portfolio.

An illustrative example of this process is provided below. For ease of illustration, the variable notation and terminology used in this illustrative example is used throughout this disclosure. However, this example should not be read to limit the scope of the present disclosure.

The various performance characteristics for an asset may be represented notationally as follows. For n assets, the expected return for asset i (i=1 . . . n) may be expressed as μi. The standard deviation for asset i may be expressed as σi, and the correlation between assets i and j may be expressed as ρij. The standard deviation (μi), expected return rate (σi), and correlation (ρij) may be predefined values associated with each asset. Those values may be selected arbitrarily, obtained from a public source (e.g., public remote data source 120), purchased from a private company (e.g., via private remote data source 120), or obtained using any other suitable method. The standard deviation and correlation values can be used to calculate a covariance value that may be expressed as

$$σ ij = \{ \begin{matrix}{σ}_{i}^{2} & if i = j \\ {σ}_{i} * {σ}_{j} * {ρ}_{ij} & if i \neq j .\end{matrix}$$

Once these values have been assigned to an asset, method 200 may proceed to step 212, in which the portfolio may be collectively analyzed to determine a weight for each asset that may indicate what percentage of the portfolio may be devoted to that asset to achieve a management strategy goal, including one of the two efficient results described above, as described in more detail below with reference to FIGS. 4-6. In some embodiments, this process may be used to calculate a generally optimized mixture of assets in a portfolio that substantially achieves a management strategy goal. As an illustrative example, the output of this process may be that the least risky collection of assets for obtaining a 10% rate of return is 20% Asset A, 40% Asset B, and 40% Asset C. As the desired rate of return varies, the allocations to each asset may vary as well. For example, using the same portfolio of assets, the least risky collection of assets for obtaining an 8% rate of return may be 80% Asset A, 20% Asset B, and 0% Asset C. In a risk vs. return plane (where risk is measured along one axis and return is measured along the other axis), the collection of optimized portfolios lie along a single line that may be referred to as an efficient frontier. For example, in the field of investing, for a defined level of return, an investor may identify the least risky collection of assets needed to achieve that level of return by picking the portfolio that appears on the efficient frontier for that level of return.

Following the illustrative example outlined above, the weights for asset i may be expressed as ωi, and may be calculated as follows:

The covariance matrix of expected returns, Σ, the portfolio weights, ω, and the expected returns, μ, can be expressed in matrix format, as

$$Σ = [ \begin{matrix}{σ}_{11} & … & {σ}_{1 n} \\ ⋮ & ⋱ & ⋮ \\ {σ}_{n 1} & … & {σ}_{nn}\end{matrix} ] , ω = ( \begin{matrix}{ω}_{1} \\ ⋮ \\ {ω}_{n}\end{matrix} ) , μ = ( \begin{matrix}{μ}_{1} \\ ⋮ \\ {μ}_{n}\end{matrix} )$$

For a particular portfolio (P), the return, μp, and risk, σp2, can be calculated as:

$${μ}_{p} = {( \begin{matrix}{ω}_{1} \\ ⋮ \\ {ω}_{n}\end{matrix} )}^{T} ( \begin{matrix}{μ}_{1} \\ ⋮ \\ {μ}_{n}\end{matrix} ) , {σ}_{p}^{2} = {( \begin{matrix}{ω}_{1} \\ ⋮ \\ {ω}_{n}\end{matrix} )}^{T} [ \begin{matrix}{σ}_{11} & … & {σ}_{1 n} \\ ⋮ & ⋱ & ⋮ \\ {σ}_{n 1} & … & {σ}_{nn}\end{matrix} ] ( \begin{matrix}{ω}_{1} \\ ⋮ \\ {ω}_{n}\end{matrix} )$$

To minimize the standard deviation, σp, at a return, π, first minimize:

$${σ}_{p}^{2} = {ω}^{T} {Σ}_{ω} = {( \begin{matrix}{ω}_{1} \\ ⋮ \\ {ω}_{n}\end{matrix} )}^{T} [ \begin{matrix}{σ}_{11} & … & {σ}_{1 n} \\ ⋮ & ⋱ & ⋮ \\ {σ}_{n 1} & … & {σ}_{nn}\end{matrix} ] ( \begin{matrix}{ω}_{1} \\ ⋮ \\ {ω}_{n}\end{matrix} ) ,$$

bound by constraints:

$$\{ \begin{matrix}{( \begin{matrix}{ω}_{1} \\ ⋮ \\ {ω}_{n}\end{matrix} )}^{T} ( \begin{matrix}{μ}_{1} \\ ⋮ \\ {μ}_{n}\end{matrix} ) = π \\ {ω}_{1} + {ω}_{2} … + {ω}_{n} = 1 ,\end{matrix}$$

which results in Lagrangian equation, L=ω^{T}Σω+λ₁(π−ω^{T}μ)+λ₂(1−ω^{T}I). Solving for the weight (ω) as a function of π, yields the following expression

$$ω ( π ) = \frac{( a {Σ}^{- 1} μ - b {Σ}^{- 1} ) π + ( c {Σ}^{- 1} I - b {Σ}^{- 1} ) μ }{a c - {b}^{2}}$$

### Where,

a=I^{T}Σ⁻¹I, b=μ^{T}Σ⁻¹I, c=μ^{T}Σ^{-1μ}.

The result of this calculation is the weight (w) that should be attributed to each asset in the portfolio to achieve an efficient result. Performing this calculation across all selected assets yields an efficient frontier of optimized portfolios.

However, the above-described technique is but one example of how to calculate the weight (ω) that should be attributed to each asset. Depending upon the type of assets under consideration, other techniques may yield a more accurate or reliable result for the weights (ω) that should be attributed to each asset in the portfolio to achieve an efficient result. One such technique involves resampling the expected return values that are associated with each asset. The re-sampling process provides a statistical model of how each asset may behave in a defined number of hypothetical scenarios. For instance in one scenario, a particular asset may slightly out-perform the expected return rate, while in another scenario, that asset may drastically-underperform the expected return rate. Thus, the re-sampling process yields several hypothetical return values for each asset. Those hypothetical return values may then be statistically analyzed to determine an expected rate of return and level of risk for each asset. As an illustrative example, the hypothetical return values may be average. Once the resampled values are calculated, they may be averaged for each asset to ascertain an average resampled rate of return for each asset. Those averaged values for each asset may be used as inputs to the equations described above in place of the expected or assumed return values.

Each set of sample values can further be optimized to form an efficient frontier of portfolios, as described in more detail below with reference to step 214 and FIGS. 5-6. A number of deficiencies arising from assets with large standard deviation values may limit the functionality of traditional resampling methodology, however. The above described framework may maximize return per unit of risk, and assets with negative return values may not be selected. Each pass of resampled values may contain negative values; however, negative values, and the magnitude of such values, are ignored when calculating mean-variance efficient portfolios. For example, because the traditional models effectively ignore the possibility of negative returns, the larger the standard deviation for an asset (i.e., the more uncertain the predicted outcome), the more likely the traditional models are to allocate to that asset. Another problem with traditional resampling methodology results from associating a fixed index to which all subsequent samples are deemed statistically-equivalent. The base or reference index is derived from historical (or user-specified) return data that is of uncertain value as a projection of future performance, and the resampled values are merely random values selected within the confidence interval of the original historical or user-specified values. Each resampled value is but a shade of the original estimate, and averaging the resampled values cannot remove the uncertainty inherent in the original estimate.

However, conventional resampling methods based on normally distributed values have technical limitations that become apparent as the number of assets considered increases. As the number of assets increases, the potential for assets with equivalent assumptions is higher, in which case, the above-described framework may be unable to make meaningful evaluations. That is, the conventional formula for minimizing risk per unit of return, given by the Lagrangian equation minφ=σ²−λμ (where is the standard deviation, μ is the expected return, and λ is the weight value), has no optimal solution when negative return and/or weight values are possible. As a result, many optimization tools that rely on such methodology may not be appropriate for portfolios containing a large number of securities, as commonly occurs as investors seek to achieve optimal diversification.

Traditional resampling methods assume that the expected return of each asset is normally distributed around a mean value. That is, the probabilities that the actual return will outperform or underperform the expected value are equal. Many tools currently available and frequently relied upon are reflective of this assumption, commonly known as the “Gaussian hypothesis.” In reality, however, many assets have heavy tailed distributions that are not normal. That is, for many assets, there may be a higher probability that the rate of return will under-perform rather than outperform the expected value, or vice versa.

In practice, many assets are observed to exhibit non-normal return behavior that cannot be adequately expressed by a standard deviation. Such limitations are exacerbated as the number of assets under consideration increases. While traditional resampling methods produce results that are certainly diversified, the process used to generate such results is simply an average of randomly chosen outcomes that could possibly occur given each asset's symmetrical return distribution. In some measurements of actual asset values, the extreme tails of the asset's return distributions are higher (i.e., contain more of the total probability) than those of the normal distribution. That is, the weight of probability of unexpected returns (positive or negative) is higher than what is implied by a normal distribution.

As one illustrative example, modern capital markets are extremely sophisticated, and financial-related analysis has become more technically complex. Statistical tools commonly used to evaluate securities are typically limited to a specific asset type and are not designed for interpreting a portfolio of diversified assets. That is, traditional tools are not designed to evaluate the risk of an overall portfolio containing assets with fundamentally different characteristics. However, several non-normal distributions may be used for modeling non-traditional asset returns, including:
Extreme value distributions
Gamma distributions
Hyperbolic distributions
Combination of two or more normal distributions
Stable distributions
t-distributions

In some embodiments, alternative distributions to normal may serve to improve the performance of a portfolio optimization process. For example, a stable distribution may be used. Stable distributions have sufficient mathematical properties and are a good alternative to normal distributions. The fundamental characteristics of stable distributions can account for certain types of observed asset return behavior that are difficult to express under the normal framework. The characteristic function of the stable distributions has four parameters, alpha (α), beta (β), gamma (c) and delta (π). The logarithm of the characteristic function for the stable family of distributions is:

$$\begin{matrix}log f ( t ) = log {\int }_{- ∞}^{∞} exp ( iut ) d P ( \tilde{u} < u ) \\ = i μ t - c {\vert t \vert}^{α} [ 1 + i β ( \frac{t}{` \vert t \vert} ) tan 〚 ( \frac{απ}{2} ) ] 〛\end{matrix}$$

The characteristic exponent a determines the height of, or total probability contained in, the extreme tails of the distribution, and can take any value in the interval 0<α≦2. The skewness of returns, β, provides a measure of asymmetry and has a value between −1 and 1. The scale parameter, c, must be a positive number between 0 and infinity. The location parameter, π, can be assigned any arbitrary real number. When α=2, the relevant stable distribution is the normal distribution. When the variance of the underlying stable distribution is infinite (α<2), the sample variance is an inappropriate measure of variability and other statistical models that assume a finite variance exists are considerably less appropriate tools for analysis. In the absence of a finite variance, estimators involving only the first powers of the stable variable have finite expectation when α is greater than 1.
Alpha (α)—stability parameter (or characteristic exponent)
Parameters: (0,2)—the stability parameter is constrained to 1<α<2.
Beta (β)—skewness parameter (undefined)
Parameters: [−1, 1]—the skewness parameter is not constrained.
Gamma (c)—scale parameter—the scale parameter is not constrained
Parameters: (0,]—the skewness parameter is not constrained.
Delta (π)—location parameter
Parameters: (−]—the location parameter is not constrained.

Of the four stable variables, α (also known as the alpha variable, stability variable, asymmetry variable, or characteristic exponent) is the most important for the purpose of determining the “best fitting” stable distribution and also is the most difficult to determine (or even approximate). Mandelbrot's stable hypothesis states that for distributions of price changes in speculative series, the variable α is in the interval 1<α<2, so that the distributions have means but their variances are infinite. Finite values of α can be approximated by applying parameter values suggested by Mandelbrot.

Assuming that most assets have fundamentally different behavior, the abandonment of standard techniques enables more accurate characterizations to be derived for multiple assets and among assets. For instance, such a framework may be more appropriate for incorporating financial derivatives, such as equity options that show non-standard return patterns. In accordance with the properties of a stable distribution, each asset's distribution can be separated into two components. The densities of return distributions are approximated and a center density value can be determined for the interval 1<α<2. That is, an equilibrium value can be found for the bottom and top 50% of return values implied by the distribution. The equilibrium value is not a “mean return value” as described by a normal distribution. Returns expected to be below or above the value are not equivalent in magnitude. Separating the distributions into two components allows downside-risk to be distinguished from upside potential. Likewise, the two different types of return variation are often presented as separate values. Different combinations of measures yield different efficient portfolios. For such cases, alternative measures—a measure of central tendency and a measure of instability—generally produce better efficient portfolios than any other combination of measures. In practice, small differences between distributions can result in different outcomes. Valuation measures can be further derived from the values. For instance, return per unit of downside-risk and, similarly, return per unit of upside potential can be expressed for valuation purposes. The favorability of an asset with a relatively little upside could be offset by a low downside valuation.

In accordance with one method used by the invention, the challenge of generating sample values based on non-normal distributions is addressed by determining the relative density of each asset's cumulative return distribution. Associating cumulative density values of an asset to that of all other assets in a portfolio enables an intuitive procedure for generating sample return values. Deriving cumulative density values requires that a finite probability distribution of return values is expressed. Further applications of density used by the methodology are more easily implemented, provided that finite return probabilities are known. Sample return values may be based on correlation coefficient values that are constant throughout the sampling process, as described in more detail below with reference to FIGS. 5-6.

After calculating the efficient frontier, method 200 may proceed to step 214. At step 214, method 200 may select an optimized portfolio. In some embodiments, step 214 may be performed by optimization engine 106 of data analyzer 102. Selecting the appropriate optimized portfolio may, in some embodiments, involve the user analyzing the efficient frontier calculated in step 212 to determine which portfolio is optimized appropriately for that user's constraints. As an illustrative example, an investment manager may select the portfolio appropriately optimized for his/her desired return/risk balance. After selecting the optimized portfolio, method 200 may continue to step 216.

At step 216, method 200 may perform other analyses of the portfolio desired by the user. As an illustrative example, a user may wish to perform a sensitivity analysis on the portfolio. In a sensitivity analysis, the user may analyze the portfolio to determine how much of the portfolio's expected return is dependent upon one particular asset. After performing the additional analyses, method 200 may proceed to step 218.

At step 218, method 200 may generate one or more reports for the user in order to present the asset analysis and/or optimization data in a more user-friendly manner. In some embodiments, step 218 may be performed by report generation engine 108 of data analyzer 102. After generating the necessary report(s), method 200 may proceed to step 220.

At step 220, method 200 may save the portfolio data. In some embodiments, data analyzer 102 may store the portfolio data in some combination of portfolio data 112 and/or remote data storage 122. As one of ordinary skill in the art would recognize, the amount of data generated by method 200 can be quite large. As a result, different configurations of data analyzer 102 and networked system 100 may have different storage capabilities and/or needs. As a result, the data generated by method 200 can be stored in any data storage electronic device configured to store the appropriate volume of data. After storing the data, method 200 may return to step 202 to await further user input.

Although FIG. 2 discloses a particular number of steps to be taken with respect to method 200, method 200 may be executed with more or fewer steps than those depicted in FIG. 2. In addition, although FIG. 2 discloses a certain order of steps comprising method 200, the steps comprising method 200 may be completed in any suitable order. For example, in the embodiment of method 200 shown, the generation of reports shown at step 218 does not occur until all analysis is complete. However, in some configurations, in may be necessary or desirable to provide the user with updates throughout the process to assist in the data analysis. Additionally, as stated above, the depicted steps of 214 and 216 may not occur in all, or even any, configurations or embodiments of method 200.

FIG. 3 illustrates a flow chart of an example method 300 for setting up a portfolio for analysis, in accordance with certain embodiments of the present disclosure. Method 300 includes updating reference data, adjusting data range and time horizon, importing new data, and saving updates to the file server.

According to one embodiment, method 300 preferably begins at step 302. Teachings of the present disclosure may be implemented in a variety of configurations of networked system 100. As such, the preferred initialization point for method 300 and the order of steps 302-308 comprising method 300 may depend on the implementation chosen. Generally, the steps 302-308 comprising method 300 correspond to step 208 of method 200, as described in more detail above with reference to FIG. 2. Likewise, the contents of steps 202-206 and 210, depicted as part of FIG. 3 for ease of illustration, are described above with reference to FIG. 2.

At step 302, method 300 may update any reference data needed for the asset analysis. As an illustrative example, this may include the past performance data associated with the selected assets. For the investment field, this may include ticker information associated with particular investment securities. In some embodiments, this data may be retrieved from some combination of asset data 110, end user computer 116, proprietary data 118, and/or remote data source 120. After updating the reference data, method 300 may proceed to step 304.

At step 304, method 300 may adjust the data range and/or time horizon necessary for analyzing the selected assets. Depending on the analysis desired, it may be necessary or desirable to specify the data range and/or time horizon under consideration. As an illustrative example, in the investment field, it may be necessary or desirable to narrow the time horizon in order to better reflect assumptions regarding the performance of a particular group of assets (e.g., a user expects an asset to perform in the future more similarly to recent performance). Similarly, it may be necessary or desirable to broaden the time horizon in order to better reflect assumptions regarding the performance of a particular group of assets (e.g., a user expects an asset to perform in the future in a manner unlike its recent performance). After adjusting the data range and/or time horizon, method 300 may proceed to step 306.

At step 306, method 300 may import new data. In some embodiments, if changes were made to the data range and/or time horizon at step 304, new asset data may be required. For example, more data may be needed to account for a broadened time horizon. This data may be loaded in a manner similar to the reference data, as described in more detail above with reference to step 302. After importing new data, if necessary, method 300 may proceed to step 308.

At step 308, method 300 may save updates. In some embodiments, data analyzer 102 may store the portfolio data in some combination of portfolio data 112 and/or remote data storage 122. As one of ordinary skill in the art would recognize, the amount of data generated by method 300 can be quite large. As a result, different configurations of data analyzer 102 and networked system 100 may have different storage capabilities and/or needs. As a result, the data generated by method 300 can be stored in any data storage electronic device configured to store the appropriate volume of data. After storing the data, method 300 may continue to step 210, as described in more detail above with reference to FIG. 2.

Although FIG. 3 discloses a particular number of steps to be taken with respect to method 300, method 300 may be executed with more or fewer steps than those depicted in FIG. 3. In addition, although FIG. 3 discloses a certain order of steps comprising method 300, the steps comprising method 300 may be completed in any suitable order. For example, in the embodiment of method 300 shown, the saving of data shown at step 308 does not occur until all data has been loaded. However, in some configurations, in may be necessary or desirable to intermittently save data to a data store in order to minimize bandwidth.

FIG. 4 illustrates a flow chart of an example method 400 for analyzing a set of assets associated with a portfolio, in accordance with certain embodiments of the present disclosure. Method 400 includes loading asset forecasts, modeling the return distribution, adjusting distribution parameters, and indicating a forecast confidence level.

According to one embodiment, method 400 preferably begins at step 402. The teachings of the present disclosure may be implemented in a variety of configurations of networked system 100. As such, the preferred initialization point for method 400 and the order of steps 402-420 comprising method 400 may depend on the implementation chosen. Generally, the steps 402-420 comprising method 400 correspond to step 214 of method 200, as described in more detail above with reference to FIG. 2. Likewise, the contents of steps 208 and 212, depicted as part of FIG. 4 for ease of illustration, are described above with reference to FIG. 2.

At step 402, method 400 may determine whether there are additional assets that require consideration. In some embodiments, step 402 may be performed by asset analysis engine 104 of data analyzer 102.

If no additional assets are required to be analyzed, method 400 may exit and proceed to step 212, as described in more detail above with reference to FIG. 2. If additional assets are required to be analyzed, method 400 may proceed to step 404.

At step 404, method 400 may select the asset to be analyzed. In some embodiments, step 404 may be performed by asset analysis engine 104 of data analyzer 102. After selecting the asset to be analyzed, method 400 may proceed to step 406. At step 406, method 400 may load a forecast associated with the selected asset. In some embodiments, step 406 may include loading data reflecting assumptions regarding the future performance of the asset. In the field of investing, for example, this data may include economic factors such as the interest rate and inflation rate, a risk-free rate, and other assumptions regarding the state of capital markets. In some embodiments, this data may be stored in some combination of portfolio data 112, end user computer 116, proprietary data 118, and/or remote data source 120. In some configurations, data regarding capital market performance assumptions may be publicly available (i.e., stored in a public configuration of remote data source 120). In the same or other configuration, the data regarding those assumptions may be proprietary to a particular user (i.e., stored in proprietary data 118). After loading the asset forecast, method 400 may proceed to step 408.

At step 408, method 400 may estimate various performance characteristics of an asset. In some embodiments, these may include the expected return rate, the level of risk, and the correlation coefficient. In some embodiments, step 408 may be performed by asset analysis engine 104 of data analyzer 102. After estimating these characteristics, method 400 may proceed to step 410.

At step 410, method 400 may calculate the approximate expressions for the probability distribution function(s) for the asset. In some embodiments, step 410 may be performed by asset analysis engine 104 of data analyzer 102. This method may, in some embodiments, have one or more statistical analyses associated with it. As an illustrative example, the optimization method may utilize a stable distribution. At step 410, asset analysis engine 104 may apply the stable distribution to the selected asset based on the distribution parameters estimated at step 408.

After calculating the distribution function(s), method 400 may proceed to step 412. At step 412, method 400 may calculate the weight to be given to the asset within the portfolio. In some embodiments, step 412 may be performed by asset analysis engine 104 of data analyzer 102.

After calculating the asset's weight, method 400 may proceed to step 414. At step 414, method 400 may determine whether or not to adjust the distribution parameters. In some embodiments, step 414 may be performed at asset analysis engine 104 of data analyzer 102. If the user decides to adjust the parameters (e.g., the α, β, ζ, and/or π values), method 400 may proceed to step 420. At step 420, method 400 may adjust the distribution parameters requested at step 414. In some embodiments, step 412 may be performed at asset analysis engine 104 of data analyzer 102. Once the parameters have been adjusted, method 400 may return to step 410.

If no modification of the distribution parameters is necessary or desired, method 400 may proceed to step 417.

At step 417, method 400 may save the asset analysis data. In some embodiments, data analyzer 102 may store the portfolio data in some combination of portfolio data 112 and/or remote data storage 122. As one of ordinary skill in the art would recognize, the amount of data generated by method 400 can be quite large. As a result, different configurations of data analyzer 102 and networked system 100 may have different storage capabilities and/or needs. As a result, the data generated by method 400 can be stored in any data storage electronic device configured to store the appropriate volume of data. After storing the data, method 400 may continue to step 418.

At step 418, method 400 may indicate the forecast confidence level. In some embodiments, step 418 may be performed by asset analysis engine 104 of data analyzer 102. In some embodiments, a confidence level may be assigned by the user to reflect the user's confidence in the assumptions underlying the applied distribution. As an illustrative example, a confidence level may be any number between 0 and 1 that can be used to modify the portfolio values. After indicating the forecast confidence level, method 400 may return to step 402, where method 400 may determine if there are any additional assets to consider. If no other assets need to be analyzed, method 400 may proceed to step 212, as described in more detail above with reference to FIG. 2.

Although FIG. 4 discloses a particular number of steps to be taken with respect to method 400, method 400 may be executed with more or fewer steps than those depicted in FIG. 4. In addition, although FIG. 4 discloses a certain order of steps comprising method 400, the steps comprising method 400 may be completed in any suitable order. For example, in the embodiment of method 400 shown, the saving of data shown at step 416 does not occur until an asset has been analyzed. However, in some configurations, in may be necessary or desirable to intermittently save data to a data store in order to minimize bandwidth. Additionally, method 400 may include additional steps. For example, method 400 may also include a step of loading a benchmark comparison for use against the modeled return distribution. In some embodiments, such a benchmark comparison may be necessary or desirable to check the accuracy of the underlying assumptions.

FIG. 5 illustrates a flow chart of an example method 500 for calculating the weight to be given a portfolio asset, in accordance with certain embodiments of the present disclosure. Method 500 includes calculating an infinitely divisible probability of asset return variance, establishing each asset's risk as a cumulative probability function, calculating the inverse of each function and converting it into a density mapping, and calculating a covariance function between scenarios.

According to one embodiment, method 500 preferably begins at step 502. The teachings of the present disclosure may be implemented in a variety of configurations of networked system 100. As such, the preferred initialization point for method 500 and the order of steps 502-608 comprising method 500 may depend on the implementation chosen. Generally, the steps 502-608 comprising method 500 correspond to step 412 of method 400, as described in more detail above with reference to FIG. 4. Likewise, the contents of steps 410 and 416, depicted as part of FIG. 5 for ease of illustration, are described above with reference to FIG. 4. In some embodiments, each step of method 500 may be performed by optimization engine 106 of data analyzer 102.

At step 502, method 500 may calculate an infinitely divisible probability of asset return variance. The asset return variance may be given by a characteristic function, of a non-degenerate distribution that is parameterized by values α (1, 2), β [−1, 1], c (0, ∞), and π (−∞, ∞), thereby describing independent measures of asymmetry (or stability), skewness, scale, and location for each asset, respectively. Once the variance has been calculated, method 500 may proceed to step 504.

At step 504, method 500 may establish each asset's risk as a cumulative probability function of the asset return variance defined by the four values of the corresponding probability distribution calculated at step 502. After establishing the assets' risk, method 500 may proceed to step 506.

At step 506, method 500 may calculate the inverse of each function and converting it into a density mapping that is uniquely defined by the probability distribution function of step 504. After calculating the inverse of each function, method 500 may proceed to step 507. At step 507, method 500 may resample asset return values for each asset comprising the portfolio, with each asset having a defined expected return and a derived risk value adjusted for an associated confidence coefficient value, each asset having a correlation with respect to every other asset of the portfolio and subject to specified minimum and maximum constraint values, c₁ and c₂, respectively. After performing the resampling, method 500 may proceed to step 508.

At step 508, method 500 may calculate a covariance function between scenarios. As an illustrative example, the traditional value at risk (“VaR”) statistic used to traditionally measure risk typically has three components: a time period, a confidence level and a loss amount (or loss percentage). The VaR at confidence level (1−ε)*100% (tail probability ε) is defined as the negative of the lower ε-quantile of the return distribution,

$$V a {R}_{ε} ( X ) = - {inf}_{x} \{ x \vert P ( X \leq x ) \geq ε \} = {F}_{X}^{- 1} ( ε )$$

Where ε ε (0, 1) and F_{X}⁻¹(ε) is the inverse of the distribution function calculated at step 506 for example. The VaR concept is used to determine a maximum loss over a given period of time at a specified level of confidence. In other words, VaR is used to identify a maximum expected loss if an imperfect confidence is assumed. Given some confidence value between 0% and 100%, the value at risk of a portfolio at the confidence level α is given by the smallest number 1 such that the probability that the loss L exceeds 1 is not larger than (1−α). For instance, a portfolio might have a 95% probability of not losing more than 10% in a year. Traditional techniques for deriving VaR are based on simulated return values. For example, if 100 sample returns are generated and 5 of the samples suggest a loss of 10% or worse, VaR analysis implies that the portfolio's returns will perform better than 10% with a confidence of 95% (or that there is a 5% chance of losing 10% or more) over a specified period.

In practice, knowing the likelihood of exceeding a specified threshold value does not provide enough information to fully understand the magnitude of return probabilities that are also in excess of that threshold. For instance, one statement might suggest a −5% VaR at 90% confidence. The −5% corresponds with the value identified at the 90% threshold, but it does not describe or imply anything about what values may exist between 90% and 95%. In some circumstances, the difference between 90% and 95% can be substantial. Conditional value at risk (CVaR) solves this problem and extends the concept of VaR to include the weighted average of values that exceed the specified confidence threshold. The CVaR of X at tail probability ε of a normal distribution is calculated as,

$$C V a {R}_{ε ( X )} = \frac{{σ}_{X}}{ε \sqrt{2 π}} exp ( - ( ( \text{?} ε ( Y ) ) \text{?} 2 ) / 2 ) - EX , \\ \text{?} \text{indicates text missing or illegible when filed}$$

where X is the VaR of the standard normal distribution, Y εN(0,1). Rather than determining a single value corresponding to a certain threshold, CVaR calculates a weighted average of all values that exceed the threshold. CVaR can be combined with analytical or scenario-based methods to optimize portfolios with a large number of securities.

For stable distributions, where α>1 and VαR_{ε}(X)≠0, the CVaR can be represented as, CVαR_{ε}(X)=σA_{ε,α,β}−μ, where the term does not depend on the scale and location parameters, and calculated as:

$${A}_{ε , α , β} = \frac{α}{1 - α} \frac{\vert {VaR}_{ε} ( X ) \vert}{πε} {\int }_{- \overline{θ} 0}^{π / 2} g ( θ ) exp ( - {\vert {VaR}_{ε} ( X ) \vert}^{\frac{α}{1 - α}} v ( θ ) ) d θ , \\ where : \\ g ( θ ) = ( sin ( α ( θ \text{?} + θ ) - 2 θ ) ) / sin α ( θ \text{?} + θ ) - \frac{α ( {cos}^{2} θ}{{sin}^{2} α ( {\overline{θ}}_{0} + θ )} , \\ v ( θ ) = ( cos αθ \text{?} ( α / ( 1 - α ) ) ( ( cos θ \text{?} ) / sin ( θ \text{?} + θ ) ) \text{?} ( α / 1 - α ) ) \\ ( cos ( αθ \text{?} + ( α - 1 ) θ ) ) / cosθ , ) = ( cosαθ \text{?} ( α / ( 1 - α ) ) \\ ( ( cosθ \text{?} ) / sin ( θ + θ ) \text{?} ( α / ( 1 - α ) ) ( cos ( αθ \text{?} + ( α - 1 ) θ ) ) / \\ \text{?} \text{indicates text missing or illegible when filed}$$

in which

$${\overline{θ}}_{0} = \frac{1}{α} arctan ( \frac{\overline{β} tan πα}{2} ) ,$$

β̅=−sin(VαR_{ε}(X))β, and VαR_{ε} is the VaR of the stable distribution at tail probability.

Conventional portfolio optimization tools may measure risk as a deviation from a mean return; expected return values are often simulated based on the specified deviation measure, generating sample return values. An asset with an expected return of 10% and standard deviation of 15% may have a sample value of −5% in one scenario; however, the sample value of −5% does not reveal anything about the variability of return at −5%. For instance, the value does not indicate whether returns of −6% or −10% are equally likely. For some assets, the probability of returning −5% and −10% may differ by less than 1%. When normally distributed measures are used, determining the probability of sample returns is simultaneously implied in the result. That is, one asset with a sample return that is two standard deviations below its expected mean value corresponds with an oppositely correlated asset that suggests a sample return that is two standard deviations above the mean in the same scenario. Therefore, methods premised on a normally-distributed risk distribution have only limited ability to distinguish the true risk-return potential of an asset. In order to evaluate a sample value, one may utilize CVaR concepts to evaluate the risk implied by each sampled return value derived from a stable distribution.

As an illustrative example, some investment securities may pay distributions periodically. Investments in such securities cannot be adequately modeled using normally distributed returns. Portfolio optimization methods based on normal approximations apply the same risk model to each asset of a portfolio. These assets are modeled according to a mean and a standard deviation that are unique to each asset individually. That is, such a process may only be capable of analyzing the risk of a portfolio under conditions characterized by fundamentally different distributions, and assume that every asset can be modeled using the same formula. Simulating values from these models for portfolio optimization purposes does not present a process that recognizes material change in the return behavior of an asset. After calculating the covariance function, method 500 may proceed to step 212, as described in more detail above with reference to FIG. 2.

At step 212, method 200 may calculate the efficient frontier based on the data provided in FIG. 5. As an illustrative example, method 200 may optimize the allocation to each asset with respect to adjusted minimum and/or maximum weight constraints calculated in each scenario. An example of this optimization is presented below:

Simulated return values are constrained for each asset as follows:

c₁*=(c₂−V(50))/Z+V(50)

c₂*=(c₂−V(50))/Z+V(50)

The first step is to solve for c₁* and c₂* of a cumulative distribution values for c₁ and c₂, where V(50) is the 50th percentile values. The outcome is equal to the inverse of the stable characteristic function at the corresponding 50^{th} percentile. The values are further integrated for each scenario and conditional value at risk may be determined. The results can be ranked to derive optimal weights

Although FIG. 5 discloses a particular number of steps to be taken with respect to method 500, method 500 may be executed with more or fewer steps than those depicted in FIG. 5. For example, method 500 may also include data saving and/or reporting steps.

FIG. 6 illustrates a flow chart of an example method 600 for calculating the weight to be given a portfolio asset, in accordance with certain embodiments of the present disclosure. Generally, method 600 may be considered a sampling methodology that accounts for negative return values generated during a simulation process, addressing one of the principal shortcomings of current portfolio optimization techniques, particularly those based on Monte Carlo sampling or other normal distribution probability models. Method 600 is an example method by which samples may be screened for certain conditional values that signal an implied level of risk. Samples with large negative values, identified according to a specified CVaR, may be assigned a penalty factor that is related to the excess CVaR. Subsequent samples may be subject to reduced favorability in terms of risk-reward by the magnitude of the penalty factor assigned. In order to do this properly, multiple loops of sample scenarios should be initialized and repeated to test for technical sampling errors that are simply coincidental. Thus, the methodology does not rely on an established base index, and unlike existing sampling techniques, samples drawn in each scenario may not be associated to a base index.

According to one embodiment, method 600 preferably begins at step 602. The teachings of the present disclosure may be implemented in a variety of configurations of networked system 100. As such, the preferred initialization point for method 600 and the order of steps 602-610 comprising method 600 may depend on the implementation chosen. Generally, the steps 602-610 comprising method 600 correspond to step 412 of method 400, as described in more detail above with reference to FIG. 4. Likewise, the contents of steps 410 and 416, depicted as part of FIG. 6 for ease of illustration, are described above with reference to FIG. 4. In some embodiments, some or all of the steps of method 600 may be performed by optimization engine 106 of data analyzer 102.

At step 601, method 600 may specify a particular drop rate. The drop rate may apply user-specified confidence conditions to risk factors identified in the portfolio optimization and selection process. The drop rate may determine criteria for changing an asset's relative favorability in a subsequent or concurrent sampling process. This type of drop rate may be used to exclude suboptimal portfolios identified by criteria specified by the user. After specifying the drop rate, method 600 may continue to step 602.

At step 602, method 600 may derive parameters from the drop rate specified at step 601. These parameters may, in some embodiments, be used to control the extent of diversification to be applied in the resampling process. It is important that confidence is applied in terms that are relative to each asset. As an illustrative example, many asset managers seek to diversify among many investments and it is likely that their forecasts for some assets may be more accurate than others, which should be accounted for in the confidence applied to each individual asset. Implementing confidence levels involves recalculation of the covariance matrix for each scenario. After deriving the parameters, method 600 may proceed to step 603.

At step 603, method 600 may resample each asset comprising a sample portfolio from each scenario, thereby generating each asset's implied distribution of return values. After resampling, method 600 may proceed to step 604. At step 604, method 600 may associate a confidence parameter value previously specified for calculating the value at risk for each asset within a simulated portfolio. After associating the confidence parameter value, method 600 may proceed to step 606.

At step 606, method 600 may calculate a value at risk based on each asset's distribution found in step 603 and confidence parameter specified in step 604. After calculating the value at risk, method 600 may proceed to step 608. At step 608, method 600 may track an associated value at risk for each asset between samples. After tracking the appropriate data, method 600 may proceed to step 610.

As step 610, method 600 may penalize an asset with a relatively high value at risk found in a sample by adjusting the risk profile of the asset in subsequent samples according to a specified drop rate, limiting allocations of efficient portfolios to the context of what was derived in prior scenarios.

Although FIG. 6 discloses a particular number of steps to be taken with respect to method 600, method 600 may be executed with more or fewer steps than those depicted in FIG. 6. In addition, although FIG. 6 discloses a certain order of steps comprising method 600, the steps comprising method 600 may be completed in any suitable order. For example, in the embodiment of method 600 shown, the specification of the drop rate at step 601 does not occur until after the estimation process at step 410. However, in some configurations, in may be necessary or desirable to define the drop rate before the asset analysis begins. For example, in configurations that do not allow user input among the data analysis process steps, a user may need or want to input a drop rate at the beginning of the process. Additionally, method 600 may include more or fewer steps. For example, method 600 may be capable of optimizing a data set to a sufficient degree solely through the implementation of steps 601-602. That is, it may not be necessary or desirable to perform steps 603-610 in order to sufficiently calculate an efficient frontier.

Using the methods and systems disclosed herein, certain problems associated with optimizing data sets associated with an asset portfolio may be improved, reduced, or eliminated. For example, the methods and systems disclosed herein allow for the application of a non-standard probability distribution function to determine an optimal portfolio for a set of assets. As part of these methods and systems, the user may customize the data model to a specific asset, for each asset, and in a manner that more accurately reflects both the actual nature of the asset and the user's own preferences for the portfolio's performance, i.e., the maximization of certain portfolio characteristics.

Although the present disclosure has been described in detail, it should be understood that various changes, substitutions, and alterations can be made hereto without departing from the spirit and the scope of the disclosure as defined by the appended claims.

What is claimed is:

1. A method of optimizing a portfolio comprising a plurality of assets, wherein the plurality of assets have a degree of interdependence, the method comprising:
estimating a first expected return rate, a first level of risk, and a first correlation coefficient for a first asset, wherein the first asset is one of the plurality of assets and the first correlation coefficient is associated with the degree of interdependence of the first asset;
estimating a second expected return rate, a second level of risk, and a second correlation coefficient for a second asset, wherein the second asset is one of the plurality of assets and the second correlation coefficient is associated with the degree of interdependence of the second asset;
applying a first non-standard probability distribution function to the first asset to determine a first distribution, wherein the first non-standard probability distribution function is based at least on the first expected return rate, level of risk, and correlation coefficient;
applying a second non-standard probability distribution function to the second asset to determine a second distribution, wherein the second non-standard probability distribution function is based at least on the second expected return rate, level of risk, and correlation coefficient; and
calculating an efficient frontier based at least on the first and second distributions.

2. The method of claim 1, further comprising presenting the efficient frontier for election from a one or more optimized portfolios, the one or more optimized portfolios based at least on an optimization of one or more performance characteristics associated with the portfolio.

3. The method of claim 1, wherein calculating the efficient frontier comprises calculating a plurality of weights to be assigned to the plurality of assets.

4. The method of claim 1, wherein applying the first non-standard probability distribution function comprises:
calculating an infinitely divisible probability of asset return variance associated with the first asset;
establishing the first asset's risk as a non-standard probability distribution unction to generate a first set of asset return values;
calculating an inverse of the non-standard probability distribution function;
converting the non-standard probability distribution function into a density mapping;
resampling the first set of asset return values to generate a second set of asset return values;
calculating a covariance function between the first and second sets of asset return values.

5. The method of claim 1, wherein applying the first non-standard probability distribution function comprises penalizing a sampled value of the first distribution according to a drop value.

6. The method of claim 1, wherein the first and second non-standard probability distribution functions are the same.

7. The method of claim 1, wherein the portfolio represents a collection of investment securities.

8. The method of claim 1, wherein the portfolio represents a collection of geological assets.

9. The method of claim 1, wherein the portfolio represents a series of medical treatments.

10. The method of claim 1, wherein the portfolio represents weather forecasting.

11. A system for optimizing a portfolio comprising a plurality of assets, wherein the plurality of assets have a degree of interdependence, the system comprising:
an asset analysis engine configured to:
estimate a first expected return rate, a first level of risk, and a first correlation coefficient for a first asset, wherein the first asset is one of the plurality of assets and the first correlation coefficient is associated with the degree of interdependence of the first asset;
estimate a second expected return rate, a second level of risk, and a second correlation coefficient for a second asset, wherein the second asset is one of the plurality of assets and the second correlation coefficient is associated with the degree of interdependence of the second asset;
apply a first non-standard probability distribution function to the first asset to determine a first distribution, wherein the first non-standard probability distribution function is based at least on the first expected return rate, level of risk, and correlation coefficient;
apply a second non-standard probability distribution function to the second asset to determine a second distribution, wherein the second non-standard probability distribution function is based at least on the second expected return rate, level of risk, and correlation coefficient; and
an optimization engine communicatively coupled to the asset analysis engine, and configured to calculate an efficient frontier based at least on the first and second distributions.

12. The system of claim 1, further comprising a report generation engine configured to present the efficient frontier for election from a one or more optimized portfolios, the one or more optimized portfolios based at least on an optimization of one or more performance characteristics associated with the portfolio.

13. The system of claim 1, wherein the optimization engine is configured to calculate the efficient frontier by calculating a plurality of weights to be assigned to the plurality of assets.

14. The system of claim 1, wherein the optimization engine is configured to apply the first non-standard probability distribution function by:
calculating an infinitely divisible probability of asset return variance associated with the first asset;
establishing the first asset's risk as a non-standard probability distribution function to generate a first set of asset return values;
calculating an inverse of the non-standard probability distribution function;
converting the non-standard probability distribution function into a density mapping;
resampling the first set of asset return values to generate a second set of asset return values;
calculating a covariance function between the first and second sets of asset return values.

15. The system of claim 1, wherein the asset analysis engine is further configured to apply the first non-standard probability distribution function by penalizing a sampled value of the first distribution according to a drop value.

16. The system of claim 1, wherein the first and second non-standard probability distribution functions are the same.

17. The system of claim 1, wherein the portfolio represents a collection of investment securities.

18. The system of claim 1, wherein the portfolio represents a collection of geological assets.

19. The system of claim 1, wherein the portfolio represents a series of medical treatments.

20. The system of claim 1, wherein the portfolio represents weather forecasting.
